(19) United States
(12) Patent Application Publication
(10) Pub. No.: US 2018/0122180 A1
(43) Pub. Date: May 3, 2018

(54) INTERACTIVE LOYALTY SYSTEM AND METHOD FOR LOTTERIES

(71) Applicant: TMS GLOBAL SERVICES PTY LTD, Brisbane (AU)

(72) Inventors: Brad BOARD, Brisbane (AU); Mike VEVERKA, Brisbane (AU); Levi PUTNA, Brisbane (AU); Greg LE SUEUR, Brisbane (AU)

(21) Appl. No.: 15/561,459

(22) PCT Filed: Mar. 24, 2016
(86) PCT No.: PCT/AU2016/050217

§ 371 Date: Sep. 25, 2017

(30) Foreign Application Priority Data
Mar. 26, 2015 (AU) 2015901093

(51) Int. Cl. G07F 17/32; G07C 15/00

(52) U.S. Cl. CPC G07F 17/329; G07C 15/006; G07F 17/3241

(57) ABSTRACT

An interactive loyalty system and method for a lottery is provided, which may help maintain interest in the lottery, at relatively little cost. The method comprises: receiving, on a data interface and from a user, a ticket identifier associated with a physical lottery ticket; generating, by a processor and in response to receipt of the identifier, a user interface including an interactive game, wherein the interactive game is associated with a game outcome; and providing a reward to the user according to the game outcome. The game may help maintain interest in the lottery, while the reward may be provided without large warehousing overheads, as the reward may be provided according to the game outcome, rather than being selected by the user.

### TECHNICAL FIELD

The present invention relates to interactive loyalty systems and methods for lotteries.

### BACKGROUND ART

Lottery loyalty programs are often used to provide secondary rewards to lottery players, to maintain interest in a lottery and to track player behaviour. Generally, points are allocated to the player for each ticket purchased, regardless of whether a ticked wins or not.

Points may be used to purchase physical items, such as electronic items, homewares and the like, much like a virtual currency specific to the loyalty program. A shopfront or warehouse is generally associated with the loyalty program, from which the players may redeem the physical items.

Loyalty programs are known to maintain the interest of players, even between games. Furthermore, loyalty programs can be used to track player behaviour, and generate statistics for individual players, or groups of players.

A problem with loyalty programs of the prior art is that they are costly for lotteries to maintain. In particular, the cost of providing a shopfront or warehouse can in some cases be more than the goods being stored.

As a result, there is a need for an improved loyalty system and method.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an interactive loyalty system and method for lotteries, which may at least partially overcome at least one of the abovementioned disadvantages or provide the consumer with a useful or commercial choice.

With the foregoing in view, the present invention in one form, resides broadly in an interactive loyalty method for a lottery, the method comprising:

receiving, on a data interface and from a user, a ticket identifier associated with a physical lottery ticket;

generating, by a processor and in response to receipt of the identifier, a user interface including an interactive game, wherein the interactive game is associated with a game outcome; and

providing a reward to the user according to the game outcome.

Advantageously, the game may help maintain interest in the lottery, at relatively little cost. Furthermore, the reward may be provided without large warehousing overheads, as the reward may be provided according to the game outcome, rather than being selected by the user from many potential options.

The method may further comprise receiving, on the data interface, a player identifier associated with the user, and associating the ticket identifier with the player identifier.

The game and/or the reward may be based at least in part on a user profile associated with the player identifier.

The identifier may comprise a code printed on the physical lottery ticket.

The code may comprise a barcode, a QR code, or a serial number. The code may be scanned by a user device of the user. Alternatively, the code may be manually entered by the user.

The identifier may be associated with a merchant where the physical lottery ticket was purchased.

The game may be generated at least in part according to the associated merchant. Alternatively or additionally, the outcome may be based at least in part upon the merchant.

The lottery may be associated with a first prize type, and the reward may be associated with a second prize type. The first prize type may be a monetary prize, and the second prize type may be a non-monetary prize, such as a physical item.

The reward may comprise rewards points, which may be used to enter into competitions by the user. The competition may comprise sweepstakes.

According to certain embodiments, the user is able to select between a pre-defined number of rewards points, and a variable number of rewards points by playing the game.

The game may comprise a selection of a plurality of game elements by the user. For example, the game may comprise a “pick a box”-type game.

The game may comprise a prize wheel which is spun or stopped by interaction from the user.

Preferably, the game includes an animation.

The method may comprise verifying, by a lottery system, the identifier associated with a physical lottery ticket, prior to providing a reward to the user.

Preferably, an outcome of the lottery is determined independently to an outcome of the interactive game.

Preferable, the method further comprises:

receiving, on the data interface and from a user, a second ticket identifier associated with a second physical lottery ticket;

generating, by a processor and in response to receipt of the identifier, a second user interface including a second interactive game, wherein the second interactive game is associated with a second game outcome;

wherein the reward is provided to the user according to the game outcome and the second game outcome.

As such, the method may comprise an interactive type loyalty system, where multiple tickets may be used together to play games and obtain a reward.

The second game outcome may be determined in part according to the first game outcome. For example, a likelihood of a successful game outcome may increase as more lottery tickets are purchased and/or games are played.

In another form, the invention resides broadly in an interactive loyalty system for a lottery, the system comprising:

a data interface, for receiving, from a user, a ticket identifier associated with a physical lottery ticket;

a processor, for:
generating, in response to receipt of the identifier, a user interface including an interactive game, wherein the interactive game is associated with a game outcome; and
providing a reward to the user according to the game outcome.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates an interactive loyalty system, according to an embodiment of the present invention;

FIG. 2 illustrates screenshot of a login screen of a lottery rewards system, according to an embodiment of the present invention;

FIG. 3 illustrates a screenshot of a balance screen of the lottery rewards system of FIG. 2, according to an embodiment of the present invention;

FIG. 4 illustrates a screenshot of a ticket scanning screen of the lottery rewards system of FIG. 2, according to an embodiment of the present invention;

FIG. 5 illustrates screenshot of a rewards game screen of the of the lottery rewards system of FIG. 2, according to an embodiment of the present invention;

FIG. 6 illustrates a further screenshot of the rewards game screen of the of the lottery rewards system of FIG. 2, illustrating the number of rewards points;

FIG. 7 illustrates a screenshot of a sweepstakes screen of the of the lottery rewards system of FIG. 2, according to an embodiment of the present invention;

FIG. 8 illustrates a screenshot of a points redemption screen of a lottery rewards system, according to an embodiment of the present invention;

FIG. 9 illustrates a screenshot of a game screen of the lottery rewards system of FIG. 8, according to an embodiment of the present invention;

FIG. 10 illustrates a further screenshot of the game screen of FIG. 9, wherein a results element is displayed;

FIG. 11 illustrates screenshot of a points redemption screen of the lottery rewards system of FIG. 8, according to an embodiment of the present invention; and

FIG. 12 illustrates an interactive loyalty method for a lottery, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

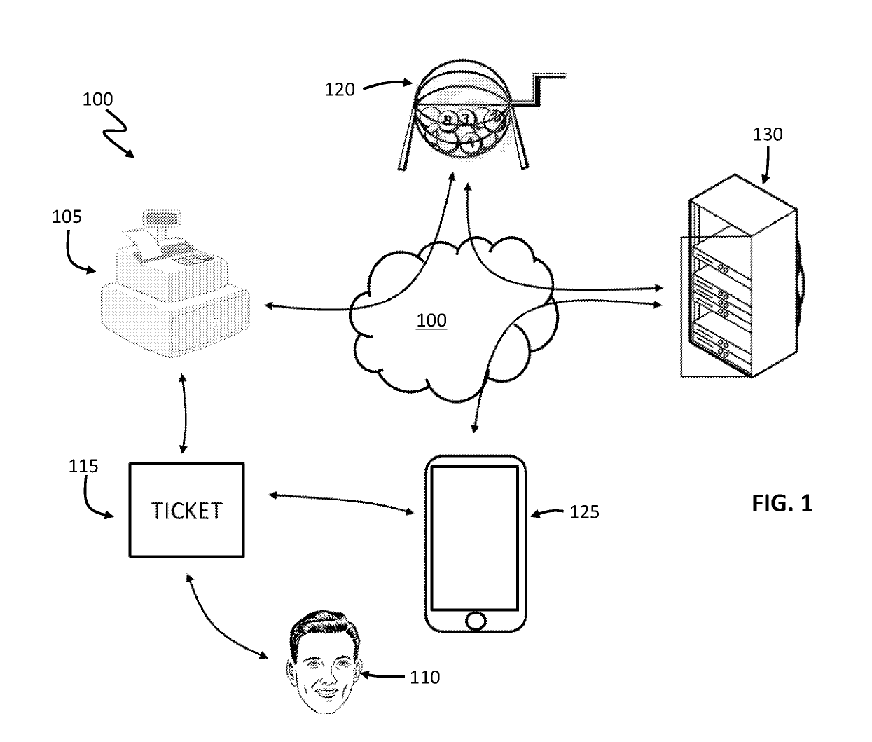

FIG. 1 illustrates an interactive loyalty system 100, according to an embodiment of the present invention. The interactive loyalty system 100, as described in further detail below, provides a loyalty system for lottery purchasers that increases player engagement and may decrease costs associated with the system 100.

The system 100 includes a merchant 105 from which a lottery player 110 purchases a lottery ticket 115. The lottery ticket 115 is generated dynamically and printed as it is purchased. The lottery ticket 115 is associated with a lottery system 120 (e.g. the Missouri Lottery), and is generated based upon an interaction between the merchant 105 and the lottery system 120.

The lottery ticket 115 further includes a barcode (not illustrated), for scanning by a smartphone 125 of the player 110. Upon scanning of the barcode, the smartphone 125 connects to a loyalty system 130 to provide details of the ticket. In particular, a code associated with the lottery ticket (e.g. all or part of a code of the barcode) is sent to the loyalty system 130, together with details of the player 110 (e.g. a player identifier).

The loyalty system 130 verifies the code associated with the ticket to confirm that the code is valid and has not been previous used. The loyalty system 130 verifies the code together with the lottery system 120.

The lottery ticket 115, and in particular the code associated with the lottery ticket 115, is associated with the merchant 105. When generating the ticket 115, the merchant 105 may add a merchant identifier to the code. Alternatively, the code may be associated with the merchant at the lottery system 120 or on the loyalty system 130. As a result, merchant specific rewards may be provided by the lottery server, as discussed below.

Upon receipt of the code, the loyalty system 130 associates the lottery ticket with an account of the user 110 and generates a reward based thereon.

The reward may comprise a fixed number of points (e.g. 1 point per ticket) that can be used to purchase products, or an interactive game having a variable outcome as outlined below.

In particular, the game may comprise a plurality of selectable icons, wherein the variable outcome of the game is provided upon selection of a selectable icon. Alternatively, other interaction of the user may define how and when the outcome is displayed, such as a timing of an interaction of the user.

The outcome may be determined based upon an interaction of the user (e.g. selection of a particular icon), or predetermined and presented to the user as if the selection of the icon determines the outcome.

According to certain embodiments, the game is customised according to the merchant, the user, or both. For example, rewards may be provided depending on where the ticket was purchased, or according to a preference of the user. Similarly, advertising may be displayed on the game according to the merchant, or past behaviour of the user.

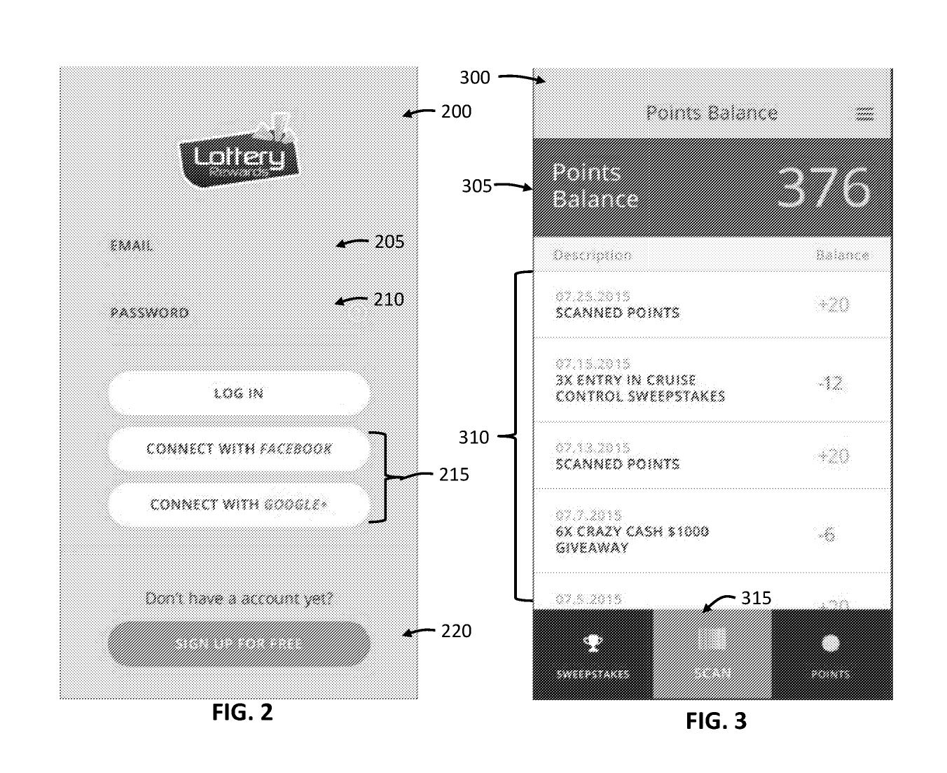

FIG. 2 illustrates screenshot 200 of a login screen of a lottery rewards system, according to an embodiment of the present invention. The lottery rewards system may be similar to the loyalty system 130 of FIG. 1.

The login page includes a username field 205 and a password field 210, in which the user enters login details in the form of a username and password. The login screen further includes social media login elements 215, which enable the user to alternatively log in using social media account details, such as Facebook login details.

Finally, the login screen includes a signup element 220, enabling the user to generate a new account. This is typically performed the first time the user uses the lottery rewards system.

FIG. 3 illustrates a screenshot 300 of a balance screen of the lottery rewards system of FIG. 2, according to an embodiment of the present invention.

The balance screen includes a points balance element 305, indicating an number of points available to the user in the lottery rewards system, and a plurality of transaction history elements 310, providing details of a transaction history associated with the user. The transaction history elements 310 include a description of each associated transaction, and a transaction amount. The transaction elements 310 are organised chronologically, and as such, provide a quick overview of recent points usage and acquisition.

Finally, the balance screen includes a menu including a points scan button 315. The points scan button can be used to activate a camera of the device, to enable scanning of a new lottery ticket to obtain rewards associated therewith.

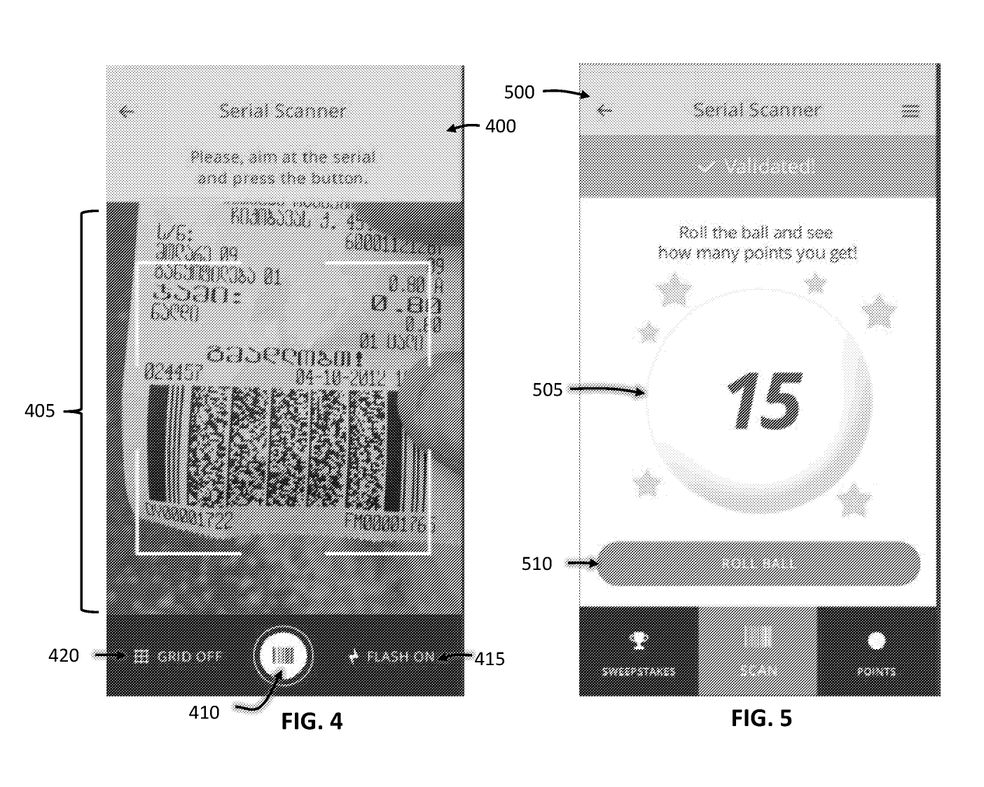

FIG. 4 illustrates a screenshot 400 of a ticket scanning screen of the lottery rewards system of FIG. 2, according to an embodiment of the present invention.

The ticket scanning screen includes a viewfinder element 405, through which an image of the camera of the device is displayed. The viewfinder element 405 enables the user to focus on the ticket, and in particular a code of the ticket for scanning. The ticket scanning screen includes a capture button 410, to capture an image of the ticket, for acquisition of the code.

Finally, the ticket scanning screen includes a flash selection element 415, for selecting whether a flash of the device is used, and a grid selection element 420, for selecting whether an assistance grid is used in the viewfinder element 405.

Upon scanning of the ticket, and validation of the associated code, a rewards game screen is provided.

FIG. 5 illustrates screenshot 500 of a rewards game screen of the of the lottery rewards system of FIG. 2, according to an embodiment of the present invention.

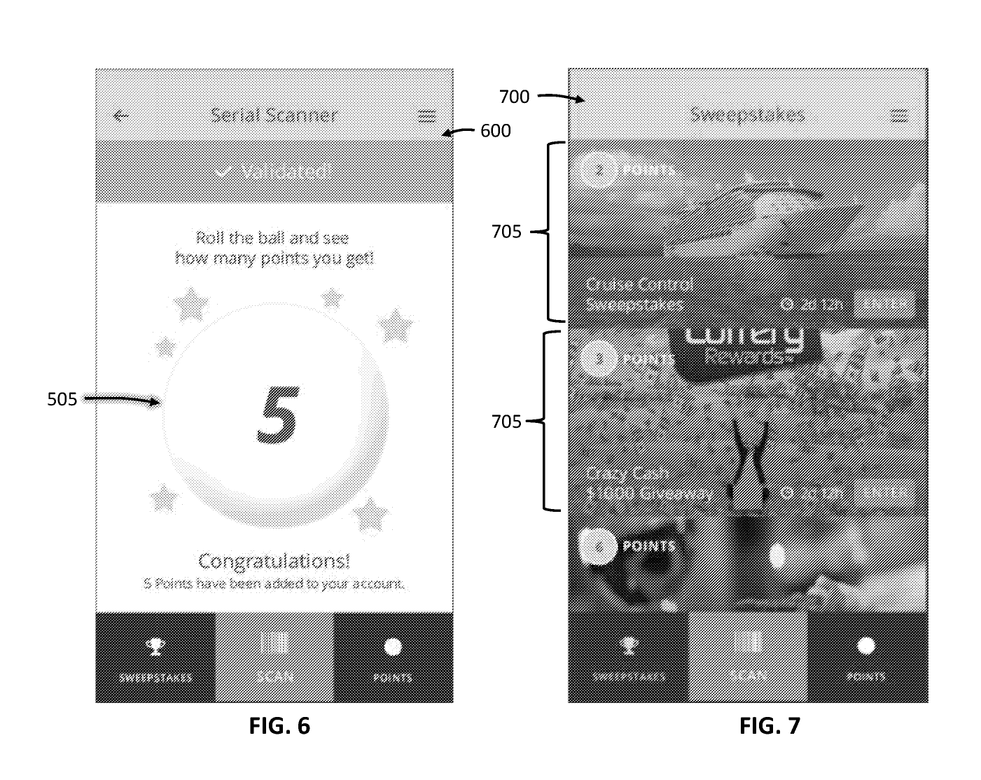

The rewards game screen includes a game element 505 and a user input element 510. The user input element 510 and the game element 505 form a game associated with the rewards of the ticket. In particular, the user presses the user input element 510, upon which a ball of the game element 505 spins. As the ball spins, different numbers are displayed on the ball, the numbers corresponding to rewards points. When the ball stops, the number of rewards points is displayed, and automatically added to an account of the user, as illustrated in FIG. 6.

According to certain embodiments, the outcome of the rewards game is a physical item. For example, the outcome may be either a physical item or points, depending on chance. Examples of physical items include homewares, gift cards and the like.

The outcome of the rewards game may be tailored to a user profile of the user. For example, a user that has indicated a sporting interest may be awarded sporting merchandise, whereas a user that has indicated a home decoration interest may be awarded homewares.

According to certain embodiments, the rewards game may be tailored to the merchant where the ticket was purchased. For example, if the ticket was purchased at a Hess gas station, a Hess gift card may be provided as a potential winning outcome. Similarly, advertising associated with the merchant may be displayed together with the game.

FIG. 7 illustrates a screenshot 700 of a sweepstakes screen of the of the lottery rewards system of FIG. 2, according to an embodiment of the present invention.

The sweepstakes screen enables the user to redeem his or her rewards points on sweepstakes (or a competition). Sweepstakes are generally a contest, where points can be transformed into entries in the contest, and one or more prizes are awarded to entries based upon chance.

The sweepstakes screen includes a plurality of selectable sweepstakes elements 705, which enable a user to select one of the sweepstakes to purchase an entry therein. Upon selection of one of the sweepstakes elements 705, and a number of entries associated therewith, entries are generated for the user and a corresponding number of points are deducted from the users account.

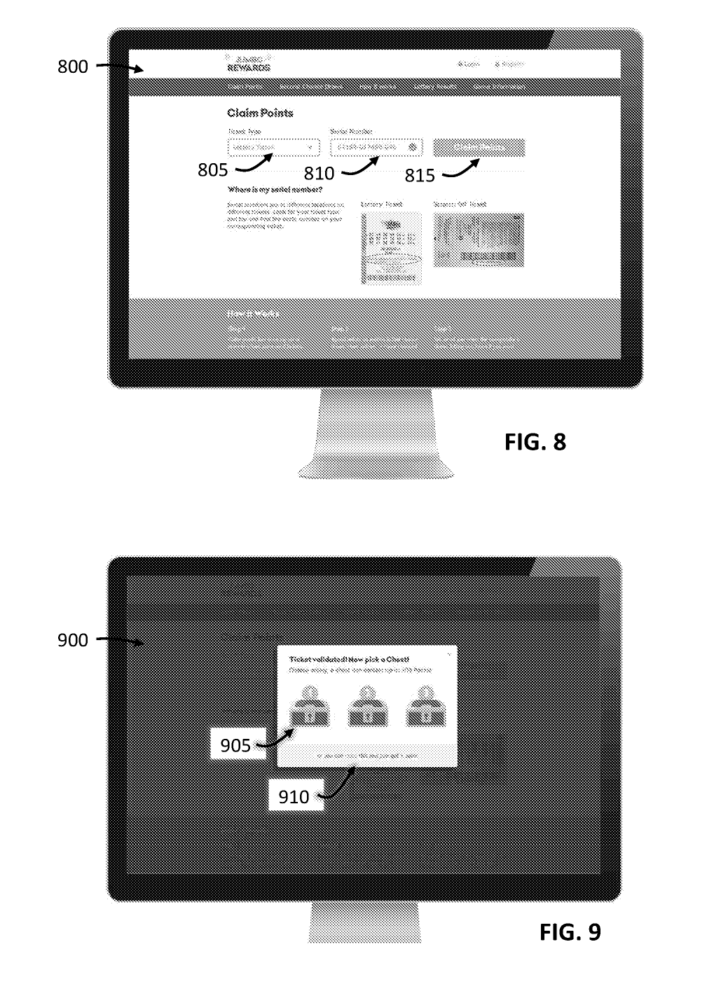

The screenshots of FIGS. 2-7 are adapted to suit a mobile computing device with a camera, internet connection and a touch screen, such as a smartphone. FIGS. 8-11 illustrates a similar lottery rewards system adapted for use on a high resolution computing device without a camera, such as a personal computer. According to certain embodiments, a device type (e.g. smartphone or PC) of the user is detected, and a display is automatically generated according to the device type.

FIG. 8 illustrates a screenshot 800 of a points redemption screen of a lottery rewards system, according to an embodiment of the present invention.

The points redemption screen includes a ticket type field 805 and a serial number entry field 810, for specifying a type of the ticket in which the redemption is being made, and a serial number of that ticket, respectively. Upon selection of a claim points button 815, the ticket type and serial number are sent to a loyalty system for verification and allocation of points.

Upon verification of the ticket, the loyalty system generates a user interface including a game.

FIG. 9 illustrates a screenshot 900 of a game screen of the lottery rewards system of FIG. 8, according to an embodiment of the present invention. The game screen includes a plurality of selectable game elements 905, wherein the game includes selection of one of the game elements 905 by the user.

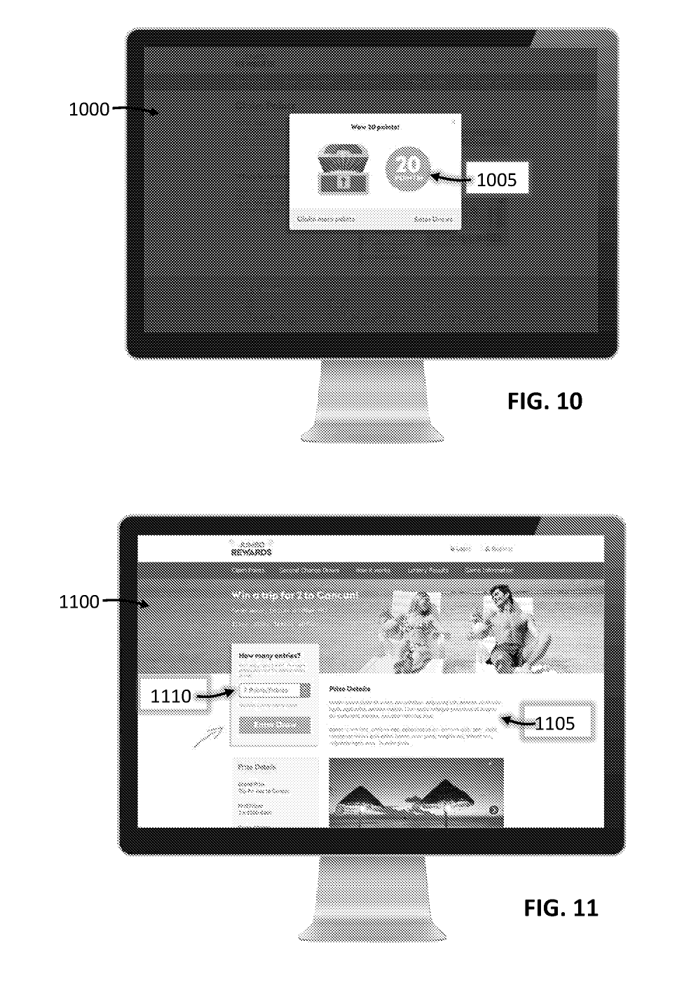

Upon selection of one of the selectable game elements 905, a results element 1005 is displayed to the user, as illustrated in FIG. 10. The results element 1005 includes a number of points won by the user.

The points redemption screen further includes a skip-game element 910, which enables the user to skip the game and simply redeem a predetermined number of points associated with the ticket.

Either way, the points won, or the predetermined number of points associated with the ticket, are automatically added to the account of the user.

The user interface including the game is arranged to provide the user with an additional thrill associated with playing a game of chance, and thus provides a further element of excitement associated with the ticket.

FIG. 11 illustrates screenshot 1100 of a points redemption screen of the lottery rewards system of FIG. 8, according to an embodiment of the present invention. The points redemption screen is associated with a particular competition, and enables the user to purchase entries to the competition.

The points redemption screen includes details of the competition, including prize details 1105 and an entry selection menu 1110. The entry selection menu 1110 enables the user to select a number of entries in the competition. Upon selection of a desired number of entries, an associated number of points are deducted from the user's account, and entries associated with the competition are generated.

While the above games generally indicate that the outcome is somewhat in control of the user (e.g. by selection of an icon or timing of the clicking of a button), an outcome of the game may be predetermined. For example, a same outcome may be provided regardless of what icon is selected by the user. In such case, the allocation of prizes to users may be performed using a predefined prize table.

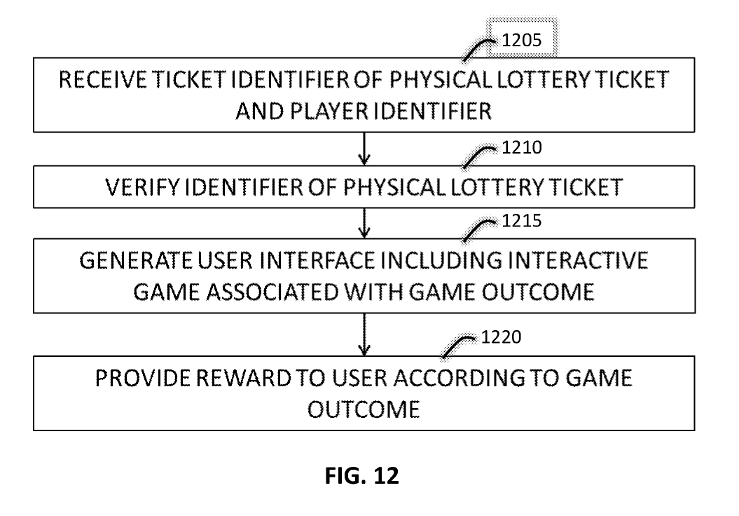

FIG. 12 illustrates an interactive loyalty method 1200 for a lottery, according to an embodiment of the present invention.

At step 1205, a ticket identifier and player identifier are received on a data interface and from a user. The ticket identifier is associated with a physical lottery ticket and the player identifier is associated with a player.

At step 1210, the identifier is verified. This may be done in association with a lottery provider.

At step 1215, and in response to receipt of the identifier, a user interface is generated including an interactive game. The interactive game is associated with a game outcome, such as a winning outcome that is associated with a reward.

At step 1220, the reward is provided to the user. The reward may be a physical item, or reward points that may be redeemed in a similar manner to a virtual currency.

The above illustrated games are provided as examples only. Alternative games include stopping a spinning disc or wheel by clicking a button. In such case, the game may appear to be influenced by skill of the user.

While physical prizes may be won by the user, the loyalty system does not need to store many physical prizes (or any prizes for that matter), as the prizes may be acquired at the end of a competition, or at predefined times selected by the loyalty provider. For example, the loyalty provider may purchase prizes in small batches, and distribute the prizes shortly thereafter. In particular, the prizes won during a game will generally correspond to prizes that are currently available in the small batch.

The skilled addressee will readily appreciate that any suitable type of code may be represented on the ticket, including a barcode, a QR code, or even a code that is manually entered into the phone, such as an alphanumeric code.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An interactive loyalty method for a lottery, the method comprising:
receiving, on a data interface and from a user, a ticket identifier associated with a physical lottery ticket;
generating, by a processor and in response to receipt of the identifier, a user interface including an interactive game, wherein the interactive game is associated with a game outcome; and
providing a reward to the user according to the game outcome.

2. The method of claim 1, further comprising: receiving, on the data interface, a player identifier associated with the user, and associating the ticket identifier with the player identifier.

3. The method of claim 2, wherein the game is based at least in part on a user profile associated with the player identifier.

4. The method of claim 2, wherein the reward is based at least in part on a user profile associated with the player identifier.

5. The method of claim 1, wherein the ticket identifier comprises a code printed on the physical lottery ticket.

6. The method of claim 5, wherein the code comprises a barcode, a QR code, or a serial number.

7. The method of claim 5, wherein the code is scanned by a user device of the user.

8. (canceled)

9. The method of claim 1, wherein the identifier is further associated with a merchant where the physical lottery ticket was purchased.

10. The method of claim 9, wherein the game is generated at least in part according to the associated merchant.

11. The method of claim 9, wherein the outcome is defined at least in part according to the merchant.

12. The method of claim 1, wherein the lottery is associated with a first prize type, and the reward is associated with a second prize type.

13. The method of claim 12, wherein the first prize type is a monetary prize type, and the second prize type is a non-monetary prize type.

14. The method of claim 1, wherein the reward comprises rewards points, which may be used to enter into a competition.

15. (canceled)

16. The method of claim 14, wherein the user is able to select between a pre-defined number of rewards points, and a variable number of rewards points by playing the game.

17. The method of claim 1, wherein the game comprises a selection of a plurality of game elements by the user.

18. The method of claim 1, wherein the game comprises a prize wheel which is spun or stopped by interaction from the user.

19.-20. (canceled)

21. The method of claim 1, wherein an outcome of the lottery is determined independently to an outcome of the interactive game.

22. The method of claim 1, further comprising:
receiving, on the data interface and from a user, a second ticket identifier associated with a second physical lottery ticket;
generating, by a processor and in response to receipt of the identifier, a second user interface including a second interactive game, wherein the second interactive game is associated with a second game outcome;
wherein the reward is provided to the user according to the game outcome and the second game outcome.

23. The method of claim 22, wherein the second game outcome is determined in part according to the first game outcome.

24. An interactive loyalty system for a lottery, the system comprising:
a data interface, for receiving, from a user, a ticket identifier associated with a physical lottery ticket;
a processor, for:
generating, in response to receipt of the identifier, a user interface including an interactive game, wherein the interactive game is associated with a game outcome; and
providing a reward to the user according to the game outcome.
